(19) United States
(12) Patent Application Publication
(10) Pub. No.: US 2025/0077819 A1
(43) Pub. Date: Mar. 6, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Keisuke Nagamine, Kanagawa (JP)

(21) Appl. No.: 18/795,327

(22) Filed: Aug. 6, 2024

(30) Foreign Application Priority Data
Aug. 30, 2023 (JP) 2023-139926

(51) Int. Cl. G06K 15/00; B41J 2/21; B41J 3/407; B41J 29/46; G06K 15/02

(52) U.S. Cl. CPC G06K 15/002; B41J 2/21; B41J 3/4075; B41J 29/46; G06K 15/022; G06K 15/024; G06K 15/1868; G06K 15/408; G06K 2215/101

(57) ABSTRACT

An information processing apparatus includes one or more processors executing the instructions to: obtain region information representing a recommended print region based on the degree of deterioration of a print head in a printing apparatus; and based on the region information and placement information representing a placement region of an object arranged in a printing target region, make a notification concerning relocation of the object.

### BACKGROUND OF THE INVENTION

### Field of the Invention

The present disclosure relates to an information processing apparatus, a method of controlling the information processing apparatus, and a storage medium.

### Description of the Related Art

Printing apparatuses using ink-jet systems include multipass printing apparatuses in which a print head reciprocates for printing and single-pass printing apparatuses that include a fixed print head and are able to print without reciprocation of the print head. The reciprocating print head is also called a serial head, and the fixed print head, which do not reciprocate, is also called a line head.

In a single-pass printer with a fixed print head, frequent printing in specific places causes the print head to be deteriorated more in portions corresponding to the specific places. This sometimes requires the whole print head to be changed even though some portions of the print head have not yet deteriorated.

In Japanese Patent Laid-open No. 2015-208966 (hereinafter, referred to as Literature 1), a single-pass printing apparatus includes plural print head units. Literature 1 discloses a technology of counting the number of dots printed with each nozzle and in a case where unevenness is observed in printing in the same region of each print head unit, prompt the user to exchange mounting positions of the print head units.

The technology of Literature 1 cannot be applied to a printer not including plural print head units. Furthermore, the technology of Literature 1 requires the user to manually exchange the mounting positions of the print head units.

### SUMMARY OF THE INVENTION

According to an aspect of the present disclosure, an information processing apparatus includes: one or more memories storing instructions; and one or more processors executing the instructions to: obtain region information representing a recommended print region based on the degree of deterioration of a print head in a printing apparatus; and based on the region information and placement information representing a placement region of an object arranged in a printing target region, make a notification concerning relocation of the object.

Further features of the present invention will become apparent from the following description of exemplary embodiments with reference to the attached drawings.

### BRIEF DESCRIPTION OF THE DRAWINGS

FIG. 1 is a block diagram illustrating an example of an information processing apparatus;

FIG. 2 is a block diagram illustrating a hardware configuration of a printing apparatus;

FIG. 3 is diagram illustrating an example of a label data layout screen of a printing application;

FIGS. 4A and 4B are diagrams illustrating label data layout examples;

FIGS. 5A to 5C are diagrams for explaining deterioration degree regions of a print head and recommended print regions;

FIG. 6 is a flowchart illustrating an example of a process to propose relocation of label data;

FIGS. 7A and 7B are diagrams illustrating the states resulting from applying recommended print regions in a recommended print region table;

FIG. 8 is a diagram illustrating the layout after relocation of label data is performed;

FIGS. 9A and 9B are diagrams for explaining the states resulting from applying recommended print regions in the recommended print region table;

FIG. 10 is a diagram illustrating the layout after relocation of label data is performed;

FIGS. 11A to 11D are diagrams for explaining deterioration degree regions of a print head and recommended print regions;

FIG. 12 is a flowchart illustrating an example of the process to propose relocation of label data; and

FIG. 13 is a flowchart illustrating an example of the process to propose relocation of label data.

### DESCRIPTION OF THE EMBODIMENTS

Hereinafter, preferred embodiments of the present disclosure will be described in detail with reference to accompanying drawings. The following embodiments do not restrict the present disclosure. All the combinations of features described in the following embodiments are not essential for solutions of the present disclosure. The same constituent components are given the same reference numerals.

### FIRST EMBODIMENT

### Information Processing Apparatus

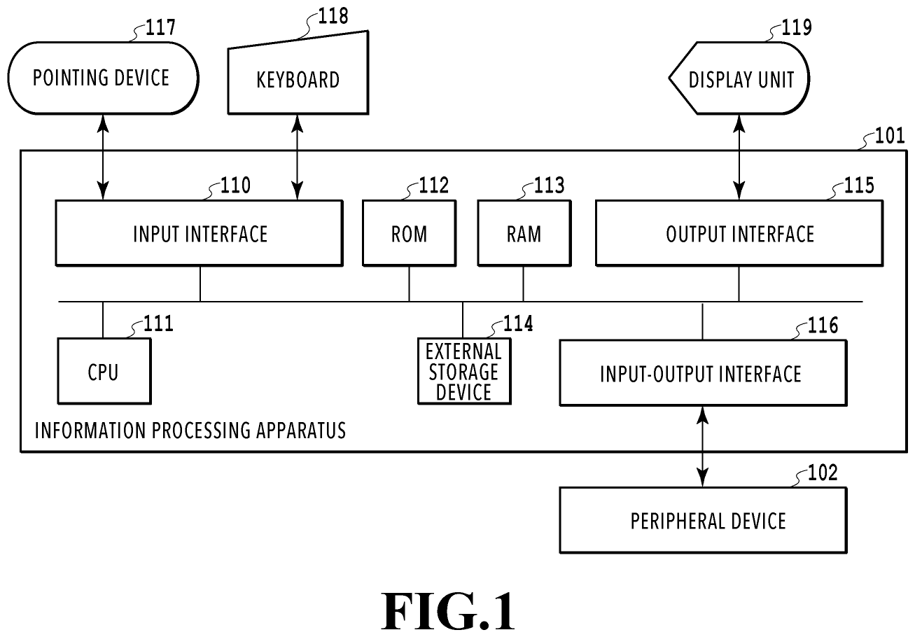

FIG. 1 is a block diagram illustrating an example of an information processing apparatus of the first embodiment. An information processing apparatus 101 includes an input interface 110, a CPU 111, a ROM 112, a RAM 113, an external storage device 114, an output interface 115, and an input-output interface 116. These components are connected to each other through a system bus. The input interface 110 is connected to input devices, such as a keyboard 118 and a pointing device 117. The output interface 115 is connected to a display device, such as a display unit 119. The input-output interface 116 is connected to a peripheral device 102.

The CPU 111 is a system controller and controls the entirety of the information processing apparatus 101, including program execution and hardware activation. The ROM 112 stores fixed data, including a control program to be executed by the CPU 111, a data table, an embedded operating system (hereinafter, referred to as an OS), and a program. In the first embodiment, each control program stored in the ROM 112 performs execution control of software, for example, such as scheduling, task switching, and interruption processing, under the control of the embedded OS stored in the ROM 112. The RAM 113 is composed of a static random-access memory (SRAM) or a DRAM, which needs a backup power supply, or the like. The RAM 113 may hold data with a not-illustrated primary battery for data backup. In this case, the RAM 113 is able to store important data, such as program control variables, without letting them volatilize. The RAM 113 also includes a memory area storing setting information of the information processing apparatus 101, management data of the information processing apparatus 101, and the like. Furthermore, the RAM 113 is used as a main memory and a working memory of the CPU 111. The external storage device 114 stores various applications, contents data to be treated by the applications, and the like.

The display unit 119 is composed of a light emitting diode (LED), a liquid-crystal display (LCD), or the like. The display unit 119 displays data and makes a notification of the state of the information processing apparatus 101. The display unit 119 may be provided with a software keyboard including numeral input keys, a mode setting key, a determination key, a cancel key, a power key, and the like. The information processing apparatus 101 thereby receives an input from a user through the display unit 119. The input-output interface 116 is a configuration that is connected to the peripheral device 102 to execute various data communications.

### Printing Apparatus

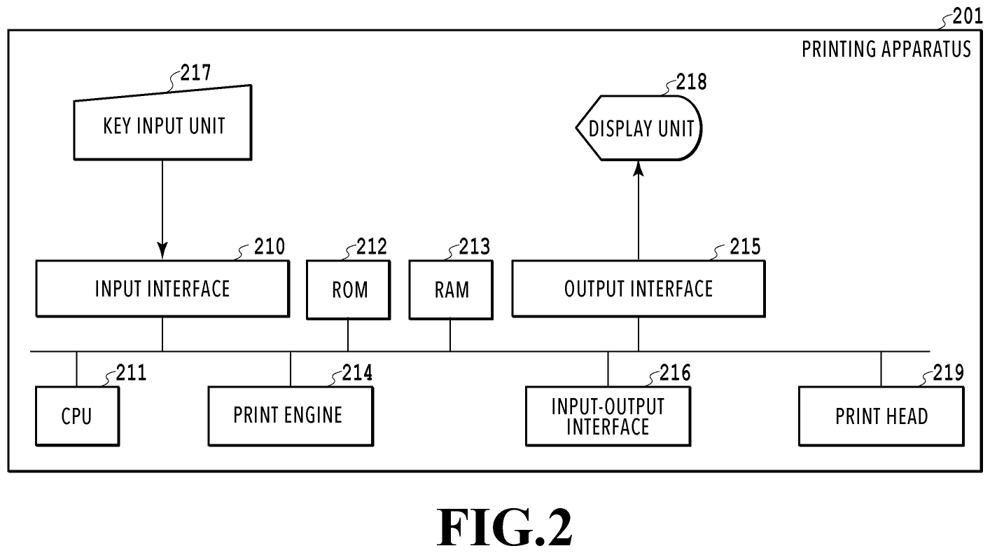

FIG. 2 is a block diagram illustrating a hardware configuration of a printing apparatus of the first embodiment. A printing apparatus 201 includes an input interface 210, a CPU 211, a ROM 212, a RAM 213, a print engine 214, an output interface 215, an input-output interface 216, a key input unit 217, a display unit 218, and a print head 219. The key input unit 217 is configured to receive an operation from the user. The key input unit 217 includes numerical input keys, a mode setting key, a determination key, a cancel key, and the like. The key input unit 217 is connected to the input interface 210. The printing apparatus 201 may be the peripheral device 102.

The display unit 218 displays the detail of print data received and the state of the printing apparatus. The display unit 218 is composed of a liquid crystal display (LCD) or the like and is connected to the output interface 215. The CPU 211 is a system controller and controls the entirety of the printing apparatus 201. The ROM 212 stores fixed data, including a control program to be executed by the CPU 211 and a data table. The RAM 213 is used as a working memory of the CPU 211 and is also utilized as a buffer for temporarily storing a print job. The print engine 214 performs printing based on data stored in the RAM 213 or a print job received from the information processing apparatus 101. The print engine 214 ejects a printing agent, such as ink, onto a printing medium, such as paper, through the print head 219 to form an image and output the result of printing. The input-output interface 216 of the printing apparatus 201 is connected to the input-output interface 116 of the information processing apparatus 101 to implement mutual communication between the information processing apparatus 101 and the printing apparatus 201. That is, the information processing apparatus 101 and the printing apparatus 201 are able to exchange information through the input-output interface 116 of the information processing apparatus 101 and the input-output interface 216 of the printing apparatus 201. The way of connecting the information processing apparatus 101 and the printing apparatus 201 can be, but is not limited to, for example, network connection or the like.

In the first embodiment, the print head 219 includes one single-pass head. The CPU 211 stores in the ROM 212, the degree of deterioration corresponding to the amount of ink ejected in each portion of the print head 219. The CPU 211 stores in the ROM 212, a region of the print head 219 where the amount of ink ejected is small and the degree of deterioration is low. The CPU 211 then sends to the information processing apparatus 101, the region of the print head 219 where the amount of ink ejected is small and the degree of deterioration is low, in response to an information request from the information processing apparatus 101.

### Printing Application

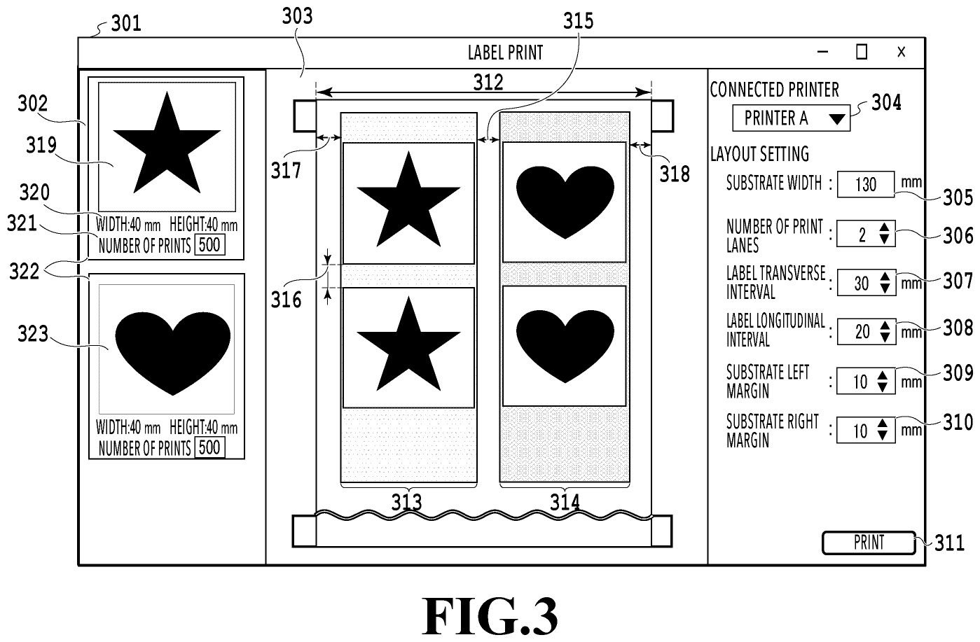

FIG. 3 is a diagram illustrating an example of a label data layout screen of a printing application that is displayed on the display unit 119 by the CPU 111 of the information processing apparatus 101 executing the printing application, which is stored in, for example, the RAM 113 or ROM 112. By using the printing application, the user is able to perform layout of label data and perform printing.

The printing application of the first embodiment is used in label printing for mainly printing labels. The printing application is used in layout of print data, called imposition. The user of the printing application is, for example, an operator at a label printing company or the like. The print data are submitted to a label printing company from the outside or is created by a designer at the label printing company or the like and is submitted to the label printing company. In the label printing company, the operator performs imposition by using the printing application so as to implement efficient printing.

Label printing generally includes a process to print a large quantity of identical labels. As a printing medium called a substrate, label printing uses a roll substrate. After the printing process is completed, cutting of the substrate on a label basis or another processing is performed in a process called a postprocess. The end-product after the postprocess is completed is, for example, roll paper with a large quantity of identical labels printed thereon. In such a manner, in label printing, identical labels are printed successively in a conveyance direction of the substrate. The region in which identical labels are printed is referred to as a lane.

In a case where two lanes are set on the substrate, for example, identical labels are printed in each lane (that is, in the conveyance direction of the substrate). In this case, as the end-products, two roll products are separately created by cutting the substrate on a label basis as described above. Thus, the end products are separate and independent even though the labels are printed through the same printing process. The operator therefore performs the work of imposing submitted data including data from plural clients so as to implement efficient printing.

The description of the printing application will be continued using FIG. 3. A label data layout screen 301 of the printing application includes, for example, a thumbnail region 302, in which thumbnails of label data are displayed. The label data layout screen 301 further includes a layout preview area 303, a connected printer setting region 304, and a print button 311. In the layout preview area 303, layout of the label data is performed. The label data layout screen 301 includes a layout setting region. The layout setting region includes a substrate width setting region 305, a number-of-print-lanes setting region 306, a label transverse interval setting region 307, a label longitudinal interval setting region 308, a substrate left margin setting region 309, and a substrate right margin setting region 310.

In the layout preview area 303, a substrate width 312 is set according to the value set in the substrate width setting region 305. Within the substrate width 312, print lanes are displayed according to the value set in the number-of-print-lanes setting region 306. Herein, “2” is set in the number-of-print-lanes setting region 306, and two lanes, including a first lane 313 and a second lane 314, are displayed sequentially starting from the left of the screen. A label transverse interval 315 between the first lane 313 and the second lane 314 is displayed corresponding to the value set in the label transverse interval setting region 307, which is 30 mm herein.

The arrangement of lanes within the substrate width 312 will be described. A substrate left margin 317, from the left end of the substrate width 312 to the left end of the first lane 313, is displayed based on the value set in the substrate left margin setting region 309. A substrate right margin 318, from the right end of the substrate width 312 to the right end of the second lane 314, is displayed based on the value set in the substrate right margin setting region 310.

In the thumbnail region 302, first label data 319 and second label data 323 are displayed. Each set of label data is also referred to as an object. Each set of label data includes a label size display region 320 and a label data number-of-prints setting region 321. In the label size display region 320, 40 mm is set as width and height, and in the label data number-of-prints setting region 321, 500 is set as the number of prints. In FIG. 3, two types of label data, including the first label data 319 and the second label data 323, are illustrated, but label data are not limited to this example. In the example of FIG. 3, the first label data 319 and the second label data 323 are selected with selection frames 322 as printing targets.

In the first lane 313, the first label data 319 is arranged. In the second lane 314, the second label data 323 is arranged. The transverse width of each lane is the same as that of the corresponding label data. Herein, both the first lane 313 and the second lane 314 are 40 mm in width. A label longitudinal interval 316, which is the interval between labels in the longitudinal direction in each lane, has the value set in the label longitudinal interval setting region 308. The label longitudinal interval 316 is displayed in 20 mm herein. The label data according to the number of prints set in the label data number-of-prints setting region 321 are arranged in the longitudinal direction in each lane.

In a case where the label size is changed due to arrangement of new label data or replacement of the arranged label data with other label data, the spaces are automatically adjusted in order of the substrate right margin 318, the substrate left margin 317, and the label transverse interval 315.

When the print button 311 is pressed, the CPU 111 stores in the ROM 212, the label layout displayed in the layout preview area. Then printing is performed in the printing apparatus 201 set in the connected printer setting region 304.

### Layout Adjustment Process

An example of layout adjustment process using the information processing apparatus 101, printing apparatus 201, and printing application having the aforementioned configurations will be described below. In the first embodiment, a description will be given of, in particular, an example in which the information processing apparatus 101 reduces the deterioration of the print head due to repeated printing of uneven layouts, by obtaining from the printing apparatus 201, a region of the print head 219 where the degree of deterioration is low.

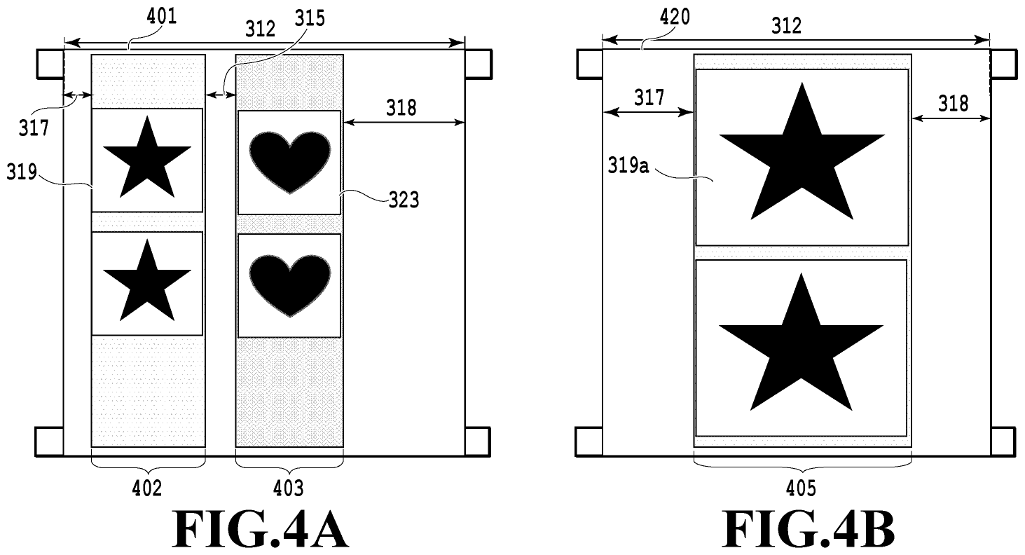

FIGS. 4A and 4B are diagrams illustrating examples of the label data layout displayed in the layout preview area 303. FIG. 4A is a diagram illustrating an example in which two types of label data are arranged. FIG. 4B is a diagram illustrating an example in which one type of label data is arranged. As illustrated in FIGS. 4A and 4B, the printing application manages information of placement information representing placement regions of label data arranged in the layout preview area 303 as a printing target region.

A layout 401 illustrated in FIG. 4A is a layout in which two lanes, including a third lane 402 and a fourth lane 403, are arranged. Specifically, the first label data 319 is arranged in the third lane 402, and the second label data 323 is arranged in the fourth lane 403. In the layout 401 illustrated in FIG. 4A, the substrate width is 180 mm; the label transverse interval 315, 10 mm; the substrate left margin 317, 20 mm; and the substrate right margin 318, 70 mm.

A layout 420 illustrated in FIG. 4B is a layout in which one lane, including a fifth lane 405, is arranged. Specifically, first A label data 319a, which has the same design as the first label data 319 and a different size from the first label data 319, is arranged. In the layout 420 illustrated in FIG. 4B, the first A label data 319a is 100 mm in width and 80 mm in height. The transverse width of the fifth lane 405 is 100 mm accordingly. The substrate width is 200 mm; the substrate left margin 317, 50 mm; and the substrate right margin 318, 50 mm.

### Recommended Print Region

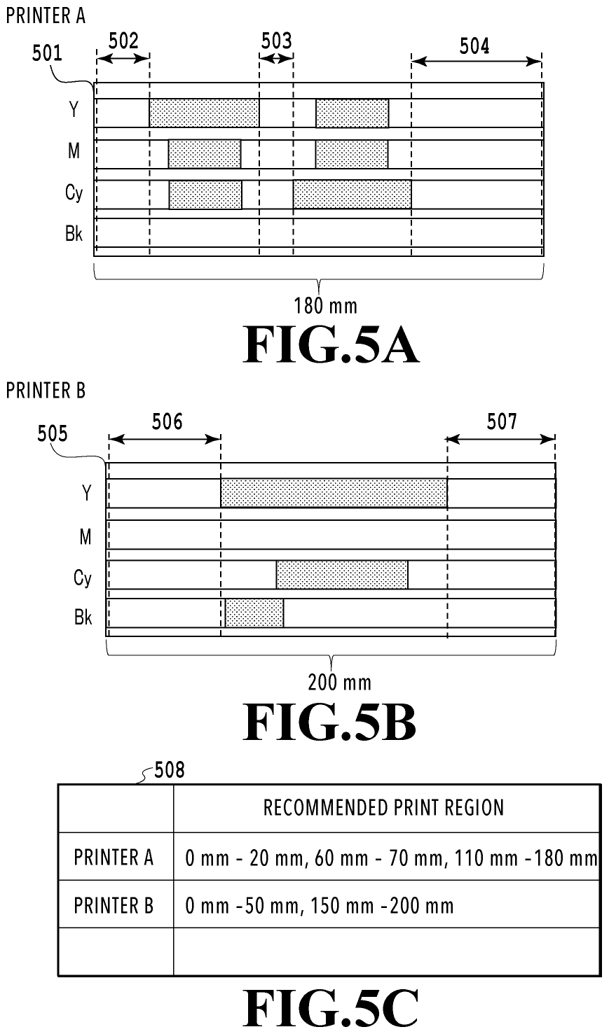

FIGS. 5A to 5C are diagrams explaining deterioration degree regions of the print head 219 of the printing apparatus 201 and recommended print regions. In this example, as the printing apparatus 201, different printers A and B are provided. The information processing apparatus 101 is connected to the printers A and B individually.

FIG. 5A is a diagram illustrating deterioration degree regions of a print head 501 of the printer A. FIG. 5B is a diagram illustrating deterioration degree regions of a print head 505 of the printer B. FIG. 5C is a diagram illustrating a recommended print region table 508 indicating recommended print regions of each printer.

FIG. 5A is a schematic top view of the print head 501 of the printer A. The print head width of the print head 501 is 180 mm. Herein, in an ejection unit ejecting ink of each color, the dot regions indicate regions where the amount of ink ejected in previous operations is greater than a predetermined threshold and the degree of deterioration is high. Furthermore, the regions of the ejection unit, other than those where the amount of ink ejected is greater than the predetermined threshold, are defined as regions where the degree of deterioration is low in the print head 501. In the first embodiment, the regions where the degree of deterioration is low in the print head ejection units of all ink colors are defined as recommended print regions. As illustrated in FIGS. 5A and 5C, for the printer A, the following regions are stored in a ROM region of the printer A as regions where the degree of deterioration is low. To be specific, starting from the left edge of the print head 501, a region 502 from 0 mm to 20 mm, a region 503 from 60 mm to 70 mm, and a region 504 from 110 mm to 180 mm are stored as regions where the degree of deterioration is low.

FIG. 5B is a schematic top view of the print head 505 of the printer B. The print head width of the printer B is 200 mm. For the printer B, in an ejection unit ejecting ink of each color, the dot regions indicate regions where the amount of ink ejected in previous operations is greater than a predetermined threshold and the degree of deterioration is high. Furthermore, the regions of the ejection unit, other than those where the amount of ink ejected is greater than the predetermined threshold, are defined as regions where the degree of deterioration is low in the print head 505. Similarly in the printer B, the regions where the degree of deterioration is low in the print head ejection units of all ink colors are defined as a recommended print region. As illustrated in FIGS. 5B and 5C, for the printer B, the following regions are stored in a ROM region of the printer B as regions where the degree of deterioration is low. That is, starting from the left edge of the print head 505, a region 506 from 0 mm to 50 mm and a region 507 from 150 mm to 200 mm are stored as regions where the degree of deterioration is low.

The recommended print region table 508 illustrated in FIG. 5C is a result of the information processing apparatus 101 obtaining the regions where the degree of deterioration is low from the printers A and B and storing the obtained regions as recommended print regions in a table form. The information of the recommended print region table 508 is updated based on the usage conditions of the print head of each printer when needed.

### Flowchart

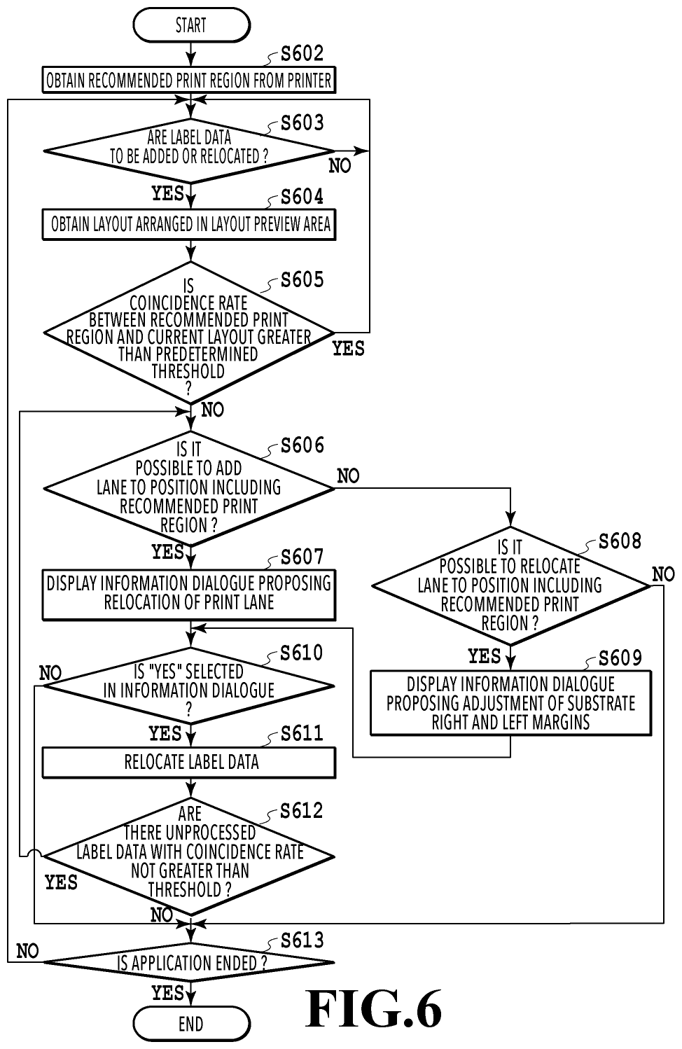

FIG. 6 is a flowchart illustrating an example of a process of the printing application of the information processing apparatus 101 to obtain recommended print regions from the printing apparatus 201 and propose relocation of label data. The process illustrated in FIG. 6 is executed by the CPU 111 of the information processing apparatus 101 loading a program stored in the ROM 112 or the external storage device 114 onto the RAM 113 and executing the program. The functions of a part or all of the steps in FIG. 6 may be implemented by hardware, such as an ASIC or an electronic circuit. Symbols “S” in the description of the process indicate steps in the flowchart (hereinafter, the same applies to flowcharts in the present specification). The process illustrated in FIG. 6 is executed on the condition that the printing application has displayed the label data layout screen 301. The process illustrated in FIG. 6 is a process to propose relocation of label data in the printing application, and actual processes including the layout process, setting process, and printing instruction in the printing application are not illustrated in the flowchart.

In S602, the CPU 111 obtains region information representing recommended print regions from a printer set in the connected printer setting region 304 displayed in the label data layout screen 301. As illustrated in FIG. 5C, the CPU 111 stores the obtained region information in the RAM 113 of the information processing apparatus 101 in the form of the recommended print region table 508. Herein, the information processing apparatus 101 is connected to the printer A illustrated in FIG. 5.

Next, in step S603, the CPU 111 determines whether an instruction to relocate or add label data displayed in the layout preview area 303 is received according to movement of the keyboard 118 or pointing device 117. If the CPU 111 determines that an instruction to relocate or add label data is received, the CPU 111 goes to S604. If the CPU 111 determines that an instruction to relocate or add label data is not received, the CPU 111 returns to S603. The operations to edit label data include deletion, in addition to relocation and addition. The deletion operation reduces label data as the printing target and will not affect the processing to reduce deterioration of the head (the processing to prolong the life). In S603, therefore, the determination is performed by using an instruction to relocate or add label data.

In S604, the CPU 111 obtains the layout displayed in the layout preview area 303. Specifically, the CPU 111 obtains placement information representing the placement region of an object arranged in the layout preview area 303 as the printing target region. In the following description, it is assumed that the CPU 111 obtains the layout 401 in FIG. 4A.

Next, in S605, the CPU 111 applies values in the recommended print region table 508 obtained in S602 to the layout and determines whether the coincidence rate between the region of each lane laid out and the recommended print regions is greater than a threshold determined in advance. If the CPU 111 determines that the coincidence rate is greater than the threshold, the CPU 111 goes to S603. If the CPU 111 determines that the coincidence rate is not greater than the threshold, the CPU 111 goes to S606.

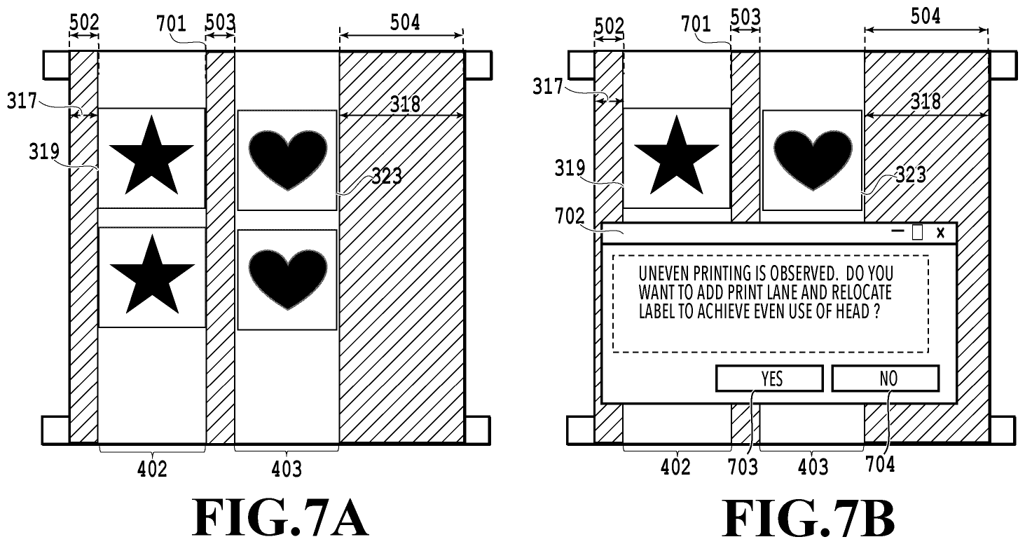

FIGS. 7A and 7B are diagrams illustrating as a layout 701, the state resulting from applying the recommended print regions in the recommended print region table 508 to the layout 401 of FIG. 4A. In the layout 701 of FIG. 7A, the recommended print regions 502, 503, and 504 are indicated by diagonal lines. The recommended print regions 502, 503, and 504 are, respectively, a range from 0 mm to 20 mm, a range from 60 mm to 70 mm, and a range from 110 mm to 180 mm where the origin is at the left edge of the substrate.

In the first embodiment, the threshold of the coincidence rate used in S605 is set to 0%. Specifically, the CPU 111 determines NO in S605 and goes to S606 only if the coincidence rate is 0%. In the layout 701, the third lane 402 ranges from 20 mm to 60 mm where the origin is at the left edge of the substrate. The fourth lane 403 ranges from 70 mm to 110 mm where the origin is at the left edge of the substrate. In the layout 701, thus, the coincidence rate between the regions of the third lane 402 and the fourth lane 403 and the recommended print regions is 0%. In this example, therefore, the CPU 111 determines NO in S605 and goes to S606. That is, the proposition to relocate label data is not performed in a case where the layout arranged in the layout preview area includes the recommended print regions by a predetermined range. On the other hand, in a case where the layout arranged in the layout preview area does not include the recommended print regions by a predetermined range, or for example, in a case where the layout arranged in the layout preview area does not overlap any recommended print region, the proposition to relocate label data is performed such that the layout includes any recommended print region as described later.

In S606, the CPU 111 determines whether it is possible to add a lane to the position including any recommended print region in the layout obtained in S604. If the CPU 111 determines that it is possible to add a lane, the CPU 111 goes to S607. If the CPU 111 determines that it is not possible to add a lane, the CPU 111 goes to S608.

The width of the lane to be added, which is used in the determination of S606, is the same as the width of a lane arranged in the layout obtained in S604. In S606, the process to determine whether it is possible to add a lane for label data arranged in the layout preview area is performed. In a case where the layout obtained in S604 includes plural lanes, the CPU 111 may determine whether it is possible to add a lane having the same width as any one of the plural lanes.

In the layout 701, for example, the substrate left margin 317 and the substrate right margin 318 include regions where some label data can be arranged. The CPU 111 determines whether a lane to be newly added completely overlaps any of the regions 502, 503, and 504, which are recommended print regions. That is, the CPU 111 determines whether the lane to be newly added is included in any recommended print region. Herein, the substrate right margin 318 of the layout 701 ranges from 110 mm to 180 mm where the origin is at the left edge of the substrate, and the transverse width thereof is 70 mm. Therefore, either the first label data 319 or the second label data 323, which have a label width of 40 mm, can be arranged in the substrate right margin 318. The region where the first label data 319 or the second label data 323 can be arranged, that is, the region where the lane to be newly added can be arranged is the substrate right margin 318. For example, in a case where the substrate right margin 318 is reduced such that the label data with a label width of 40 mm can be arranged and a lane is added in a range from 110 mm to 150 mm where the origin is at the left edge of the substrate, the lane completely overlaps the recommended print region 504, which ranges from 110 mm to 180 mm where the origin is at the left edge of the substrate. In the layout 701, for example, the CPU 111 determines that it is possible to add a lane and goes to 607.

In S607, the CPU 111 displays an information dialog 702 in the display unit 119 as illustrated in FIG. 7B. FIG. 7B illustrates an example of screen transition in the display unit 119. Herein, the information dialogue 702 including the layout 701 is displayed in the layout preview area 303. The recommended print region 504 is visualized in the example illustrated in FIG. 7B but does not need to be visualized. The information dialogue 702 includes a message asking the user whether to add a print lane and relocate label data. The information dialogue 702 includes a region that can receive an instruction from the user to relocate or not relocate labels. After S607, the CPU 111 goes to S610.

In S610, the CPU 111 determines whether a YES selection button 703 is pressed in the information dialogue 702 displayed in S607. If the CPU 111 determines that the YES selection button 703 in the information dialogue 702 is pressed, the CPU 111 goes to S611. If the CPU 111 does not determine that the YES selection button 703 in the information dialogue 702 is pressed, that is, if the CPU 111 determines that a NO selection button 704 in the information dialogue 702 is pressed, the CPU 111 goes to S613 without performing relocation of label data.

In S611, the CPU 111 performs relocation of label data. Specifically, the CPU 111 relocates label data laid out in the layout preview area 303. After S611 is completed, the CPU 111 goes to S612.

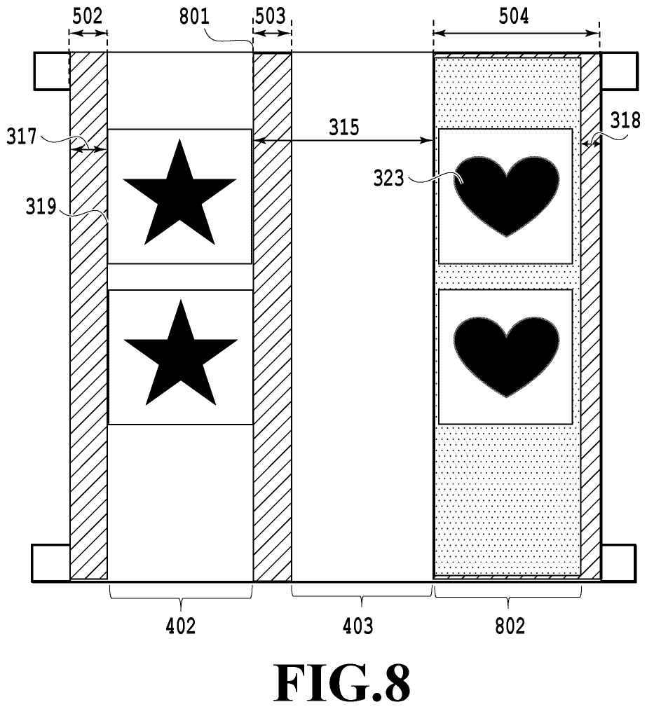

FIG. 8 is a diagram illustrating a layout 801, which is the layout after label data are relocated from the layout 701. In the example of FIG. 8, the CPU 111 reduces the substrate right margin 318 of the layout 701 to 30 mm and add an additional lane 802 in the range from 110 mm to 150 mm where the origin is at the left edge of the substrate. The CPU 111 relocates the second label data 323, which is arranged in the fourth lane 403 adjacent to the additional lane 802, to the additional lane 802. The second label data 323 is thereby removed from the fourth lane 403. In the example described in the first embodiment, the CPU 111 relocates label data adjacent to the additional lane. However, the present disclosure is not limited to this example. The label data to be relocated may be selected by the user or may be the farthest label data from the additional lane. In the description of this example, one set of label data is determined to be relocated. However, in a case where plural lanes can be added, plural sets of label data may be selected as label data to be relocated.

In S612, the CPU 111 determines whether there are unprocessed label data with a coincidence rate not greater than the threshold. Specifically, in a case where there are plural sets of label data that are laid out in the layout preview area 303 with a coincidence rate not greater than the threshold, the CPU 111 determines whether the processing for all label data is completed. If there are any unprocessed label data, the CPU 111 goes to S606. If there are no unprocessed label data, the CPU 111 goes to S613.

In S613, the CPU 111 determines whether the application ends. If the application is determined to not end, the CPU 111 goes to S603. If the application is determined to end, the CPU 111 terminates the process of the flowchart illustrated in FIG. 6.

Next, the description of the flowchart in FIG. 6 will be continued using another specific example. In the example, in S602, recommended print regions are obtained from the printer B illustrated in FIG. 5B, and in S604, the layout 420 in FIG. 4B is obtained.

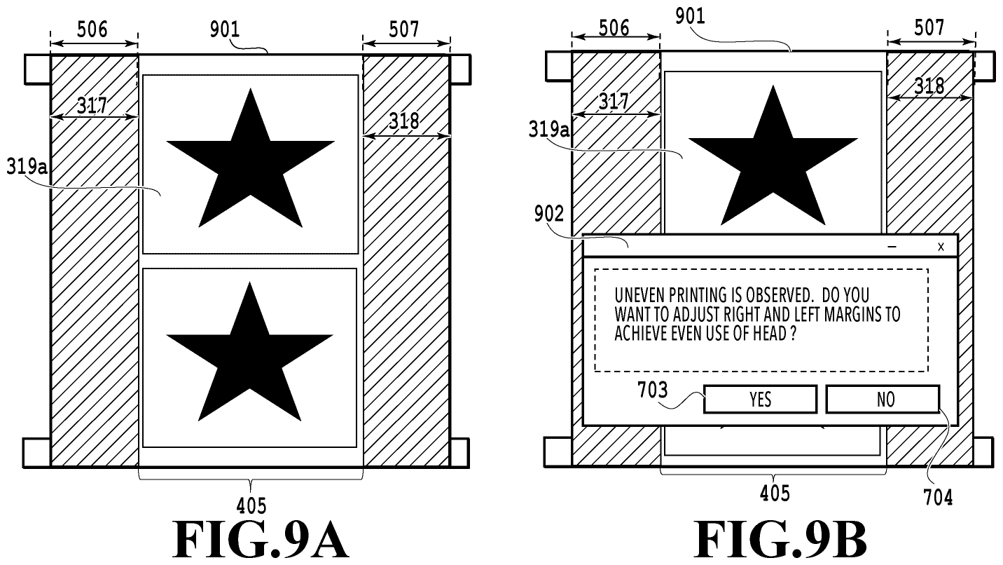

In S605, the CPU 111 applies values in the recommended print region table 508 obtained in S602 to the layout and determines whether the coincidence rate between the region of the lane laid out and the recommended print regions is greater than a threshold determined in advance. FIGS. 9A and 9B are diagrams illustrating as a layout 901, the state resulting from applying the recommended print regions in the recommended print region table 508 to the layout 420 in FIG. 4B. In the layout 901 illustrated in FIG. 9A, recommended print regions 506 and 507 are indicated by diagonal lines. The recommended print regions 506 and 507 are, respectively, a range from 0 mm to 50 mm and a range from 150 mm to 200 mm where the origin is at the left edge of the substrate. The threshold of the coincidence rate is set to 0% also in this example. That is, the CPU 111 determines NO in S605 only if the coincidence rate is 0%. In the layout 901, the fifth lane 405 ranges from 50 mm to 150 mm where the origin is at the left edge of the substrate. The coincidence rate between the fifth lane 405 and the recommended print regions 506 and 507 is therefore 0%. The CPU 111 then determines NO in S605 and goes to S606.

In S606, the CPU 111 determines whether it is possible to add a lane to the position including any recommended print region in the layout obtained in S604. In the layout 901, for example, the substrate left margin 317 and the substrate right margin 318 include a region where some label data can be arranged. The CPU 111 determines whether the lane to be newly added completely overlaps any of the regions 506 and 507, which are recommended print regions. In this example, the substrate left margin 317 of the layout 901 ranges from 0 mm to 50 mm where the origin is at the left edge of the substrate and has a transverse width of 50 mm. The substrate right margin 318 ranges from 150 mm to 200 mm where the origin is at the left edge of the substrate and has a transverse width of 50 mm. Therefore, it is not possible to add a lane in which to arrange the first A label data 319a having a label width of 100 mm. The CPU 111 thus determines NO in S606 and goes to S608.

In S608, the CPU 111 determines whether it is possible to relocate a lane to the position including any recommended print region in the layout obtained in S604. If the CPU 111 determines that it is possible to relocate a lane to the position including any recommended print region, the CPU 111 goes to S609. If the CPU 111 determines that it is not possible to relocate a lane to the position including any recommended print region, the CPU 111 goes to S613.

In S608, the CPU 111 changes the width of the substrate left margin 317 of the layout 901 or the substrate right margin 318 and determines whether a part of the fifth lane 405 overlaps the range of the region 506 or 507, which is a recommended print region. In the layout 901, the substrate left margin 317 ranges from 0 mm to 50 mm where the origin is at the left edge of the substrate. In a case where the substrate left margin 317 is reduced and the fifth lane 405 is relocated to the range from 0 mm to 50 mm where the origin is at the left edge of the substrate, a part of the relocated lane overlaps the recommended print region 506, which ranges from 0 mm to 50 mm where the origin is at the left edge of the substrate. The CPU 111 therefore determines YES in S608 and goes to S609.

In S609, the CPU 111 displays an information dialogue proposing adjustment of substrate right and left margins in the display unit 119. Specifically, the CPU 111 displays an information dialogue 902 as illustrated in FIG. 9B. Next, in S610, the CPU 111 determines whether the YES selection button 703 is pressed in the displayed information dialogue 902. If the YES selection button 703 in the information dialogue 902 is pressed, the CPU 111 goes to S611. If the NO selection button 704 in the information dialogue 902 is pressed, the CPU 111 goes to S613. In S611, the CPU 111 performs relocation of label data.

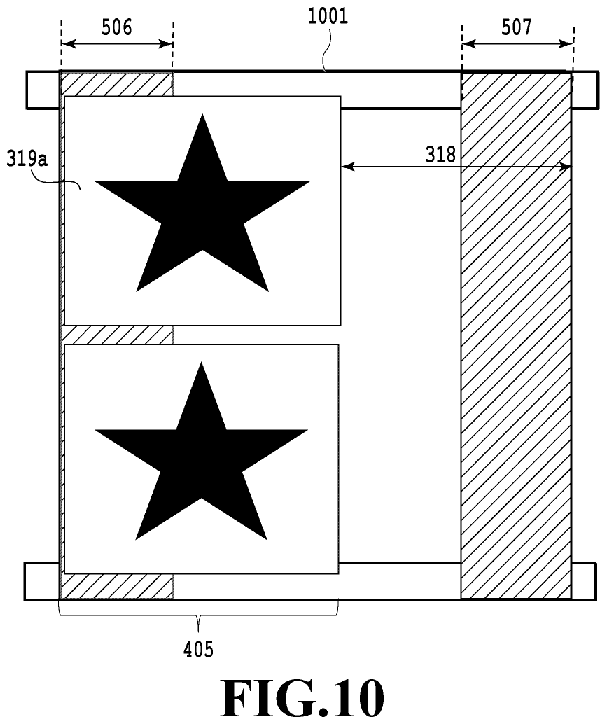

FIG. 10 is a diagram illustrating a layout 1001, which is the layout after label data are relocated from the layout 901. In the example of FIG. 10, the CPU 111 reduces the substrate left margin 317 of the layout 901 to 0 mm and relocates the fifth lane 405 to a position of 0 mm where the origin is at the left edge of the substrate. In this example, the width of the substrate left margin 317 is adjusted. However, the present disclosure is not limited to such a mode. The CPU 111 may adjust the substrate right margin 318. In the described example, the fifth lane 405 is relocated to the position of 0 mm where the origin is at the left edge of the substrate. However, the present disclosure is not limited thereto. The position to which the lane is to be relocated may be selected by the user. In the description of this example, the target of relocation is one set of label data. However, the target of relocation may include plural sets of label data.

In the aforementioned specific example, either lane addition or lane relocation is proposed. However, the present disclosure is not limited thereto, and both lane addition and lane relocation may be proposed. For example, in some cases, plural sets of label data are laid out in the layout preview area 303, and lane addition can be performed for one of the plural sets of label data. However, for another set, lane addition cannot be performed while lane relocation can be performed. In such a case, it is possible to propose both lane addition and lane relocation by repeating the process through S612.

In the example described in the first embodiment, the threshold used in determination of the coincidence rate in S605 is set to 0%. However, the threshold is not limited to this example. The threshold can be properly set to another value, such as 50% or 70%. The threshold may be configured to be freely changed by the user.

According to the first embodiment, it is possible to reduce deterioration of the print head as described above. Specifically, in the first embodiment, the information processing apparatus 101 obtains regions of the print head 219 where the degree of deterioration is low from the printing apparatus 201 and determines recommended print regions. By proposing a printing place through the printing application so as to perform printing using the recommended print regions, it is possible to reduce deterioration in particular places of the print head and thereby prolong the life of the print head.

In a general printer, the work of changing the layout, such as lane addition or relocation, results in changes in the entire layout of the print product, thus changing the impression of the print product. In the first embodiment, which performs label printing, the substrate is cut in a postprocess after printing, thus creating separate print products. Therefore, proposing lane addition or relocation, which will involve changes in layout, cannot affect print products, further reducing deterioration of a print head.

### SECOND EMBODIMENT

In the example described in the first embodiment, the information processing apparatus 101 reduces the deterioration of the print head due to repeated printing of uneven layouts by obtaining from the printing apparatus 201, a region of the print head 219 where the degree of deterioration is low. In the second embodiment, an example will be described in which the deterioration of the print head due to repeated printing of uneven layouts is reduced by holding history information of past print regions within the printing application. The basic configuration of the example of the second embodiment is the same as the example described in the first embodiment, and the differences therebetween will be mainly described hereinafter.

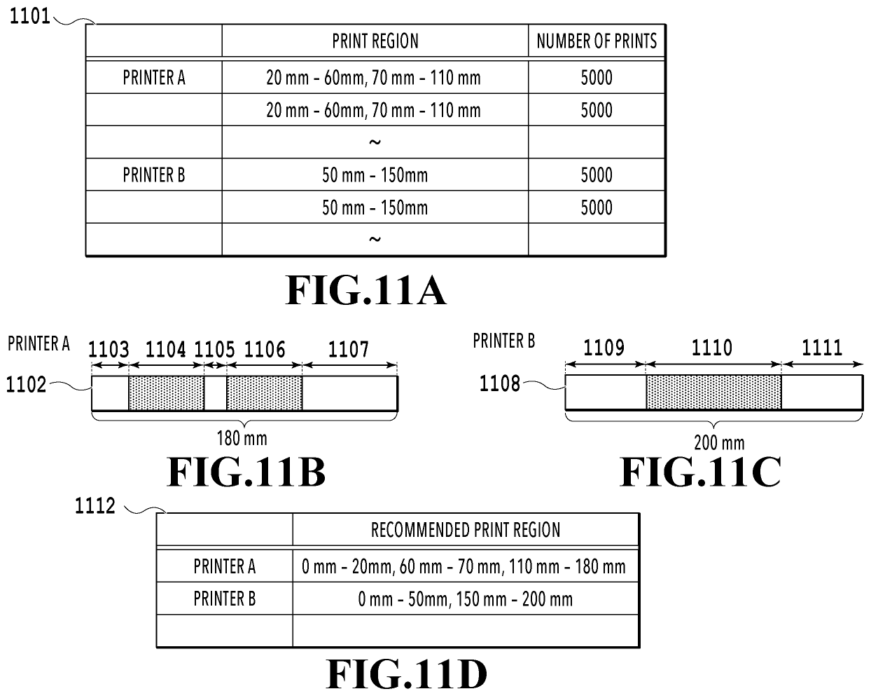

FIGS. 11A to 11D are diagrams for explaining deterioration degree regions of the print head 219 of the printing apparatus 201 and recommended print regions. In an example illustrated in FIGS. 11A to 11D, the print region and the number of prints of label data are stored in the ROM 112 of the information processing apparatus 101 in the form of a table 1101 each time the print button 311 of the printing application is pressed. In the second embodiment, similarly, the printers A and B are provided as the printing apparatus 201 and are individually connected to the information processing apparatus 101. Similar to the first embodiment, the print head width of a print head 1102 of the printer A is 180 mm, and the print head width of a print head 1108 of the printer B is 200 mm.

The table 1101 stores history information of past print regions and numbers of prints. The table 1101 reveals that the printer A has repeated printing in ranges from 20 mm to 60 mm and from 70 mm to 110 mm starting from the left edge of the print head 1102. The table 1101 also reveals that the printer B has repeated printing in a range from 50 mm to 150 mm starting from the left edge of the print head 1108.

In the second embodiment, the CPU 111 is configured to determine that the degree of deterioration of the print head is high in a case where printing is performed in the same region for ten thousand times or more. In the print head 1102 of the printer A, the CPU 111 therefore determines that the degree of deterioration is high in the following regions. Specifically, starting from the left edge of the print head 1102, the degree of deterioration is determined to be high in a region 1104 from 20 mm to 60 mm and a region 1106 from 70 mm to 110 mm, which are indicated by dot regions. The CPU 111 determines the following regions, which are the regions of the print head 1102, other than the regions 1104 and 1106, as regions where the degree of deterioration is low: starting from the left edge of the print head 1102, a region 1103 from 0 mm to 20 mm, a region 1105 from 60 mm to 70 mm, and a region 1107 from 110 mm to 180 mm. These regions are determined as regions where the degree of deterioration is low.

For the print head 1108 of the printer B, the CPU 111 determines that the degree of deterioration is high in the region 1110 from 50 mm to 150 mm starting from the left edge of the print head 1108, which is indicated by a dot region. The CPU 111 determines, starting from the left edge of the print head 1108, a region 1109 from 0 mm to 50 mm and a region 1111 from 150 mm to 200 mm, which are the regions of the print head 1108, other than the region 1110, as regions where the degree of deterioration is low.

The CPU 111 defines the regions where the degree of deterioration is determined to be low as described above, as recommended print regions and stores the regions in the RAM 113 of the information processing apparatus 101 in the form of the table 1112. The information of the table 1112 is properly updated each time printing is performed.

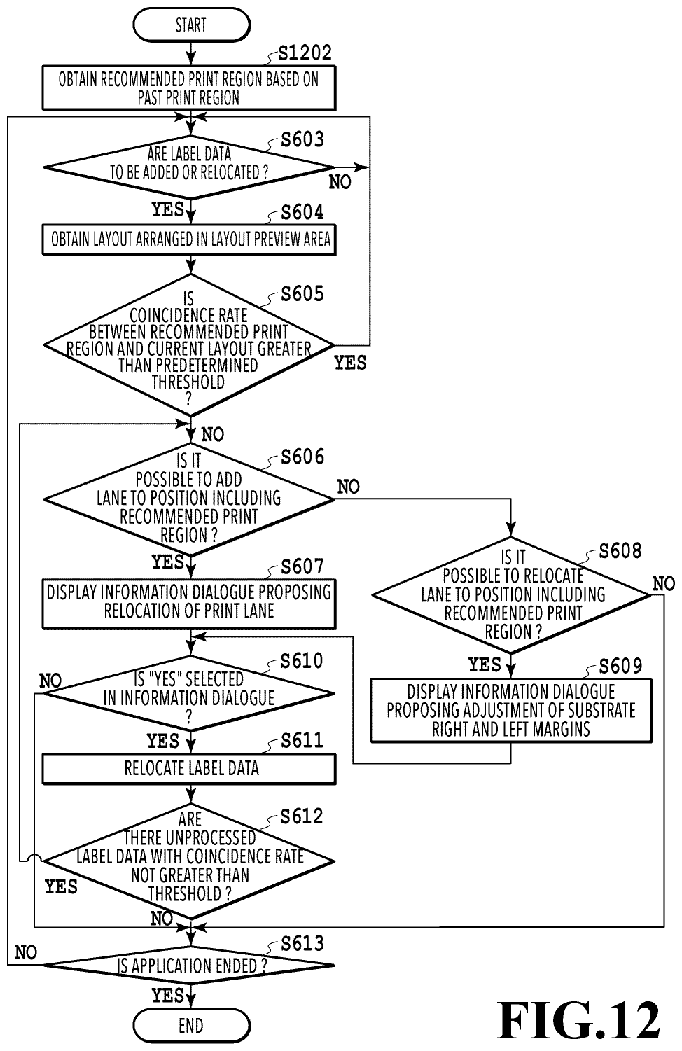

FIG. 12 is a flowchart illustrating an example of the process of the printing application of the information processing apparatus 101 to obtain recommended print regions from the printing apparatus 201 and propose relocation of label data. The process illustrated in FIG. 12 is implemented by the CPU 111 of the information processing apparatus 101 loading a program stored in the ROM 112 or the external storage device 114 onto the RAM 113 and executing the program. The functions of a part or all of the steps in FIG. 12 may be implemented by hardware, such as an ASIC or an electronic circuit. The process illustrated in FIG. 12 is executed on the condition that the printing application has displayed the label data layout screen 301 in a similar manner to the example described in FIG. 6.

In S1202, the CPU 111 obtains past print regions of the printer set in the connected printer setting region 304 displayed in the label data layout screen 301 from the table 1101. The CPU 111 then stores recommended print regions in the RAM 113 of the information processing apparatus 101 in the form of the table 1112. The processing from S603 to S613 in FIG. 12 is the same as the processing from S603 to S613 in FIG. 6 described in the first embodiment, and the description thereof is omitted herein.

As described above, according to the second embodiment, the deterioration of the print head due to repeated printing of uneven layouts can be reduced by holding information of past print regions for each printer within the printing application. Furthermore, the second embodiment is useful in a case where the information processing apparatus is connected to a printing apparatus not holding information of print regions or a printing apparatus that is not able to transmit information of print regions.

### THIRD EMBODIMENT

The first and second embodiments are described on the assumption that the information processing apparatus 101 is connected to the single-pass printing apparatus 201. In a third embodiment, a description will be given of an example in which relocation of label data is proposed as described in the first or second embodiment in an environment where the information processing apparatus 101 is connected to a multi-pass printer and a single-pass printer.

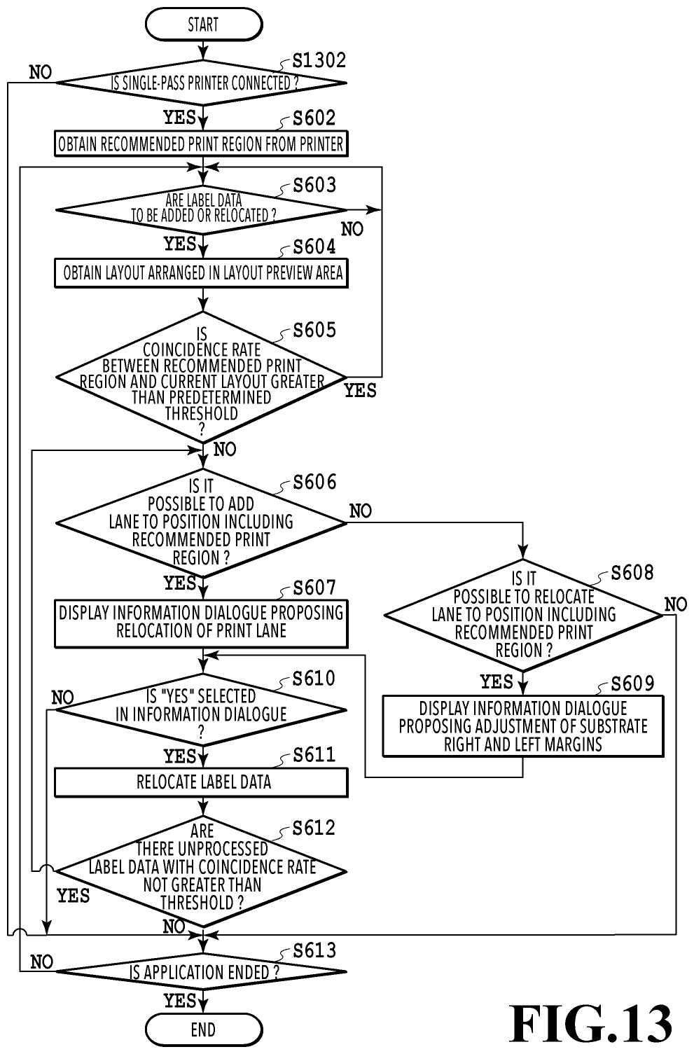

FIG. 13 is a flowchart illustrating an example of a process of a printing application of the information processing apparatus 101 to obtain recommended print regions from the printing apparatus 201 and propose relocation of label data. The process illustrated in FIG. 13 is implemented by the CPU 111 of the information processing apparatus 101 loading a program stored in the ROM 112 or the external storage device 114 onto the RAM 113 and executing the program. The functions of a part or all of the steps in FIG. 13 may be implemented by hardware, such as an ASIC or an electronic circuit. The process illustrated in FIG. 13 is executed on the condition that the printing application has displayed the label data layout screen 301 in a similar manner to the example described in FIG. 6. The flowchart in FIG. 13 illustrates a behavior in the case where the information processing apparatus 101 is connected to a single-pass printer and a multi-pass printer.

In S1302, the CPU 111 determines whether the printer set in the connected printer setting region 304 is a single-pass printer. The CPU 111 may communicate with the printing apparatus 201 and perform the determination based on the information obtained from the printing apparatus 201. The ROM 112 of the information processing apparatus 101 may hold the printing method of each printer, and the CPU 111 may perform the determination based on the held information. If the CPU 111 determines that the information processing apparatus 101 is connected to a single-pass printer, the CPU 111 goes to S602. If the CPU 111 determines that the information processing apparatus 101 is not connected to any single-pass printer, the CPU 111 goes to S613.

The processing from S602 to S613 is the same as the processing from S602 to S613 of the first embodiment described in FIG. 6, and the description thereof is omitted herein. The processing in S602 may be the processing in S1202 in FIG. 12 as described in the second embodiment.

As described above, according to the third embodiment, the proposition to relocate label data is performed in a case where a single-pass printer that requires consideration of the deterioration of the print head due to uneven print data is set. In a case where the information processing apparatus 101 is connected to a multi-pass printer, it is possible to reduce unnecessary propositions, thus preventing the user's operability from being reduced.

### Other Embodiments

In the aforementioned embodiments, the printing apparatus 201 includes one print head by way of example. However, the printing apparatus 201 may include two or more print heads. Specifically, plural head units may be provided in the width direction of the substrate so that the print heads are provided along the width direction of the substrate as a whole. In a case where the printing apparatus 201 includes two or more print heads, recommended print regions may be provided for each print head, for example.

In the aforementioned embodiments, label printing is performed by way of example. However, the present disclosure is not limited thereto. The present disclosure is applicable to any printing mode as long as the printing mode includes a printing process using a print head.

In the aforementioned embodiments, recommended print regions are described as regions that has low frequency ejection of any ink color. However, the present disclosure is not limited thereto. Recommended print regions may be determined depending on the contents of label data as a printing target. For example, it is assumed that label data uses only a particular ink color. In this case, a region that has not experienced ejection of the particular ink color may be determined as a recommended print region. Recommended print regions may be dynamically determined depending the contents of data as a printing target.

In the aforementioned embodiments, label data are used as an example of objects to be laid out. The objects to be laid out are not limited to label data. The objects to be laid out may be data in any form, such as photographs, figures, or texts.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-139926, filed Aug. 30, 2023, which is hereby incorporated by reference wherein in its entirety.

What is claimed is:

1. An information processing apparatus comprising:
one or more memories storing instructions; and
one or more processors executing the instructions to:
obtain region information representing a recommended print region based on the degree of deterioration of a print head in a printing apparatus; and
based on the region information and placement information representing a placement region of an object arranged in a printing target region, make a notification concerning relocation of the object.

2. The information processing apparatus according to claim 1, wherein
the instruction to make the notification includes determining based on the region information and the placement information whether to relocate the object and making the notification in a case where the object is determined to be relocated.

3. The information processing apparatus according to claim 1, wherein
the instruction to make the notification includes making the notification in a case where the coincidence rate between the recommended print region represented by the region information and the placement region represented by the placement information is not greater than a threshold.

4. The information processing apparatus according to claim 1, wherein
the instruction to make the notification includes making a notification to relocate the object to a position included in the recommended print region represented by the region information.

5. The information processing apparatus according to claim 1, wherein
the instruction to make the notification includes making a notification to relocate the object to a position partially including the recommended print region represented by the region information.

6. The information processing apparatus according to claim 1, wherein
the notification is configured to receive an instruction to relocate the object and an instruction not to relocate the object,
the one or more processors further executing the instructions to relocate the object, wherein
the instruction to relocate the object includes relocating the object in a case where the instruction to relocate the object is received and not relocating the object in a case where the instruction not to relocate the object is received.

7. The information processing apparatus according to claim 1, wherein
the region information is obtained by obtaining information of the degree of deterioration of the print head from the printing apparatus.

8. The information processing apparatus according to claim 1, wherein
the region information is obtained based on a history of print instructions outputted to the printing apparatus.

9. The information processing apparatus according to claim 1, wherein
the print head is able to eject inks in multiple colors, and
the recommended print region represented by the region information is a region where consumption of at least some of the inks in multiple colors is lower than a predetermined threshold.

10. The information processing apparatus according to claim 1, wherein
the region information is obtained in a case where the print head in the printing apparatus is a single-pass print head, and
the region information is not obtained in a case where the print head in the printing apparatus is not a single-pass print head.

11. The information processing apparatus according to claim 1, wherein
the object is label data.

12. The information processing apparatus according to claim 1, wherein
the object is repeatedly printed in a conveyance direction of a substrate on which the object is to be printed.

13. A method of controlling an information processing apparatus, comprising:
obtaining region information representing a recommended print region based on the degree of deterioration of a print head in a printing apparatus; and
based on the region information and placement information representing a placement region of an object placed in a printing target region, making a notification concerning relocation of the object.

14. A non-transitory computer readable storage medium storing a program which causes a computer to execute:
obtaining region information representing a recommended print region based on the degree of deterioration of a print head in a printing apparatus; and
based on the region information and placement information representing a placement region of an object placed in a printing target region, making a notification concerning relocation of the object.
